(19) United States
(12) Patent Application Publication
(10) Pub. No.: US 2024/0243460 A1
(43) Pub. Date: Jul. 18, 2024

(54) Satellite Antenna

(71) Applicant: FUBA Automotive Electronics GmbH, Bad Salzdetfurth (DE)

(72) Inventor: Micha SCHULTZ, Bad Salzdetfurth (DE)

(21) Appl. No.: 18/517,555

(22) Filed: Nov. 22, 2023

(30) Foreign Application Priority Data
Dec. 9, 2022 (DE) 102022132788.4

(51) Int. Cl. H01Q 1/28; H01Q 1/50; H01Q 21/26

(52) U.S. Cl. CPC H01Q 1/288; H01Q 1/50; H01Q 21/26

(57) ABSTRACT

A satellite antenna comprises an electrically conductive base plate above which an electrically conductive structure is arranged that comprises a ring conductor having a center. The ring conductor is electrically conductively connected to vertical radiators and the vertical radiators are each capacitively coupled to the base plate at a coupling point.

The invention relates to satellite antennas, in particular for GNSS and SDARS applications in the automotive sector. Typically, such antennas are circularly polarized and their preferred direction of radiation is in the range of the zenith.

Existing satellite antenna solutions for automotive applications usually have the property that they only cover a narrow frequency range of around 50 MHZ (for example for GNSS applications) with a sufficiently good performance (gain, axial ratio, . . . ). This is due to the limited volumes of the installation spaces in typical installation situations in cars (shark fin, systems installed in a concealed manner, etc.), but also due to the frequency position of the useful bands to be covered (GNSS: L5&L2 band from 1.16-1.25 GHz and L1&L band from 1.525-1.61 GHz; SDARS: 2.32-2.345 GHZ). Such solutions should typically radiate or receive mainly above the horizon and in particular in the direction of the zenith. Therefore, these antennas are usually realized with an electrically conductive base plate below the actual antenna structure that ensures that the antenna patterns are only directed into the half-space above the horizon or that the antenna pattern is reflected in that direction by the base plate.

This measure has the disadvantage that it restricts the usable frequency range of the antenna to approximately the 50 MHz bandwidth already mentioned. Due to the narrow bandwidth and the associated necessary high quality of such antennas, they are also comparatively expensive and not robust with respect to external influences.

It is the object of the present invention to provide a satellite antenna that has an improved bandwidth and a compact design and can be manufactured inexpensively.

This object is satisfied by the features of claim 1. Advantageous embodiments of the invention are described in the description, in the drawing, and in the dependent claims.

According to a first advantageous embodiment, the ring conductor can be formed as a regular polygon, wherein the vertical radiators are centrally arranged between the corners of the ring conductor. Unlike conventional satellite antennas, in which the vertical radiators are arranged at the center or at the corners of a mostly square ring conductor, the corners of the ring conductor are free in space in this embodiment. The polygon can be designed as a square, a rectangle, a hexagon, or another regular polygon, wherein, in all the cases, the vertical radiators can each in particular be centrally arranged between two adjacent corners of the ring conductor.

Due to the above-described arrangement of the vertical radiators between two corners of a ring conductor, the possibility results of folding the corners of the ring conductor in the direction of its center or (relative to the base plate), for example, bending the corners upwardly or folding them inwardly. According to a further advantageous embodiment, a ring conductor can hereby be designed that is cross-shaped in a plan view or that encloses a cross-shaped surface.

In such embodiments, the ring conductor has a plurality of branches having track sections which extend in parallel with one another and in which the current components running against one another largely cancel one another out in each branch.

According to a further advantageous embodiment, the ring conductor can be at least sectionally inclined and in particular dome-shaped with respect to the base plate. The antenna geometry of a radome contour above the antenna can hereby be easily adapted.

According to a further advantageous embodiment, at least one vertical radiator can be formed as slit and can in particular have two legs spaced apart in parallel. Such a slit formation can take place starting from the ring radiator and can extend up to the coupling point or even up to and into a feed pad of the coupling point. Due to the current components running against one another on the resulting parallel legs of the vertical radiators, these vertical legs become almost “electrically invisible”. The electrical connection path between the feed feet is extended so that the resulting antenna can be used at lower frequencies for the same given installation space volume.

According to a further advantageous embodiment, at least one vertical radiator can be U-shaped. In this embodiment, the vertical radiator likewise has two legs that are spaced apart in parallel and that are connected at their lower sides to a transverse web that can be connected to the coupling point.

According to a further advantageous embodiment, at least one vertical radiator can be angled at an obtuse angle at its end remote from the coupling point to enable an optimization of the installation volume. The vertical radiator can here be angled towards the center or away from the center.

According to a further advantageous embodiment, the ring conductor can have sections that extend orthogonally to the base plate, wherein these sections can in particular connect to sections of the ring conductor extending in parallel with the base plate. Due to this design, satellite antennas can be realized that are significantly higher than they are wide compared to conventional solutions, whereby a monopole-like geometry results. Nevertheless, in contrast to a monopole antenna, such an antenna is circularly polarized and its main radiation direction is predominantly formed in the direction of the zenith or omnidirectionally (in the upper half-space). Due to such a design, the space requirement in the horizontal dimension is significantly reduced so that a plurality of such antennas can be positioned next to one another in a space-saving and flexible manner. New design possibilities hereby result for the realization of complex multi-antenna systems in confined installation spaces.

According to a further advantageous embodiment, the ring conductor can have sections extending orthogonally to the base plate and merging into a respective vertical radiator. This can also contribute to a very slim and space-saving design of the satellite antenna. The same applies to a further advantageous embodiment in which the ring conductor is angled multiple times, for example 8 times, by 90°. It can also be advantageous if the ring conductor merges in a coplanar manner into the vertical radiators.

According to a further aspect of the present invention, the ring conductor can be replaced by two dipoles that in particular cross and that are connected at their ends to a respective vertical radiator. Such a satellite antenna differs from a conventional satellite antenna that comprises a ring conductor that is connected to capacitive coupling surfaces via vertical radiators. Of typically four coupling surfaces, one or two are typically fed, whereby a circular excitation of the antenna is generated. In the following, only the excitation at two coupling surfaces is considered. A circular radiation is achieved by excitations electrically shifted by 90°. One excited coupling surface and the oppositely disposed coupling surface here each form a “sub-radiator” (the other two coupling surfaces form a further sub-radiator that is positioned geometrically orthogonally to the first sub-radiator). When correctly dimensioned, both sub-radiators are almost ideally decoupled from one another, even though they are galvanically connected to one another by a ring or by a galvanic contact at the center.

In the embodiment with two dipoles instead of a ring conductor, the ring is so-to-say increasingly reduced in size so that it is reduced to a central connection point at the center of the sub-radiators. A capacitively fed cross dipole consisting of, for example, two dipole sub-radiators galvanically coupled at the center is hereby produced. Such an antenna can also be used as a satellite antenna. Since there is no longer a ring structure, other antennas (e.g. adjacent 5G antennas or WIFI antennas and the like) can be brought into the near region of the central connection point of this antenna from all four sides.

Such an antenna thus offers additional possibilities for new antenna positionings and antenna geometries. It can be designed more flexibly than a conventional ring conductor antenna since there is no longer any need for a ring structure. The struts to the central connection point and also the vertical position of the central connection point can be designed almost arbitrarily so that it becomes possible to adapt the shape of the antenna smoothly, e.g. to a round/convex radome shell above the antenna. Since the bandwidth of such an antenna is typically proportional to, for instance, the volume enclosed by the antenna structure, a very good bandwidth utilization of a given installation space is thereby enabled.

As described above, the two dipoles can be galvanically coupled at a crossing point. However, according to another advantageous embodiment, there is also the possibility of galvanically isolating the two dipoles at a crossing point. Two galvanically completely separated, capacitively fed dipoles are hereby produced. This embodiment offers the possibility of further, new antenna positionings. The separated dipole branches can be arranged in a T shape or also in a V shape or, according to a further embodiment, can also be positioned completely separately from one another, wherein it can be advantageous to maintain the orthogonal alignment of the individual dipoles for a good polarization purity. Despite this extreme positioning, a good functioning as an overall antenna with two sub-radiators is furthermore provided. The separated dipoles can be designed as identical parts, which represents an additional technical production advantage.

According to a further aspect of the present invention, in one embodiment with a ring conductor, a second ring conductor is arranged in a near region of the ring conductor, in particular above the ring conductor, and is not galvanically coupled to the electrically conductive structure. In the case of a patch antenna, the ring conductor can also be arranged above the patch antenna, in particular in its near region.

By adding a closed, conductive ring in the near region of the antenna, its usable bandwidth is multiplied (typically to a plurality of 100 MHZ) and thus enables a very robust and broadband antenna solution. With a suitable dimensioning, the entire GNSS frequency range and also the intermediate range of 1.16-1.61 GHz can be covered by an antenna that is then virtually frequency-independent.

The additional ring can in particular be positioned in the near region of the antenna (e.g. a few millimeters above the antenna).

The further ring conductor is not galvanically coupled to the actual antenna structure. This can be solved mechanically, for example, by inserting the further ring conductor as a metal structure into a cover hood above the antenna (radome) or by applying the further ring conductor as a foil with a conductor structure at or in the cover hood. The further ring conductor can also be integrated into an already present holder. Furthermore, the further ring conductor can be used to concentrate the antenna pattern in certain preferred directions. It is hereby possible to shift the main radiation direction of the antenna from the zenith to the horizon, if desired. This property of the further ring conductor depends on its dimensioning.

The conductor track width of the ring structure influences the usable bandwidth of the antenna: a higher conductor width enables higher antenna bandwidths and an even more robust performance than a smaller conductor track width. The ring can be dimensioned so that the frequency at which just the wavelength fits on the ring (hereinafter called the “ring natural frequency” f_{eig}) is in the range or close to the useful band to be covered. This means that the mean or electrical length lₘ of the ring just has to satisfy the condition

$${I}_{m} = {λ}_{eig} = \frac{c}{{f}_{eig}} .$$

Here, λ_{eig} is the wavelength at the ring natural frequency and c is the propagation speed of the wave on the ring (in air, this corresponds to the speed of light c₀). If the ring natural frequency is above the useful band, the antenna pattern is concentrated in the direction of the zenith. If the ring natural frequency is below the useful band, it becomes possible to shape the antenna pattern in a more monopole-like manner (main radiation direction close to the horizon). This is atypical for such satellite antennas, but the additional ring makes such a design possible.

The distance between the ring and the electrically conductive structure is to be selected such that the ring is in the near field of the antenna. Typically, for the given frequency ranges, these are distances in the millimeter range.

The main advantage of an additional ring above an existing ring antenna (or also a patch antenna) is that a broadening of the range with very good matching for the original antenna results due to the additional resonance of the added ring and the coupling to the antenna thereunder. Due to this increased range with very good matching, the usable bandwidth of the antenna is then significantly increased.

According to a further advantageous embodiment, it can be advantageous if the ring conductor of the satellite antenna and the second ring conductor have the same geometric shape, i.e., for example, if they are both designed as a square or a rectangle.

According to a further aspect of the present invention, it relates to an antenna arrangement that has at least two satellite antennas of the above-described kind that both have a ring conductor and whose ring conductors overlap one another in a plan view. In such an antenna arrangement, a plurality of satellite antennas of the above-described kind can be placed in one another (e.g. to cover GNSS-L1 and GNSS-L2 simultaneously). The influencing of an inner ring conductor by an outer ring conductor is smaller here. The antenna patterns of the inner ring conductor are less influenced (whereby the gain of the inner ring is in particular improved towards the zenith) and the isolation between the rings is more favorable. This embodiment thus offers the possibility of improving the overall antenna performance of a combined antenna arrangement. New embodiments hereby become possible. A plurality of such antennas—or even conventional satellite antennas—can be placed in one another completely three-dimensionally as in a shell model.

Compact antenna shapes and a flexible positioning of the feed surfaces (also in one another) hereby become possible. Thus, the antennas can also be nested in one another due to the flexible positioning capability of the capacitive coupling surfaces.

The present invention will be described in the following purely by way of example with reference to different embodiments and to the enclosed drawings. There are shown:

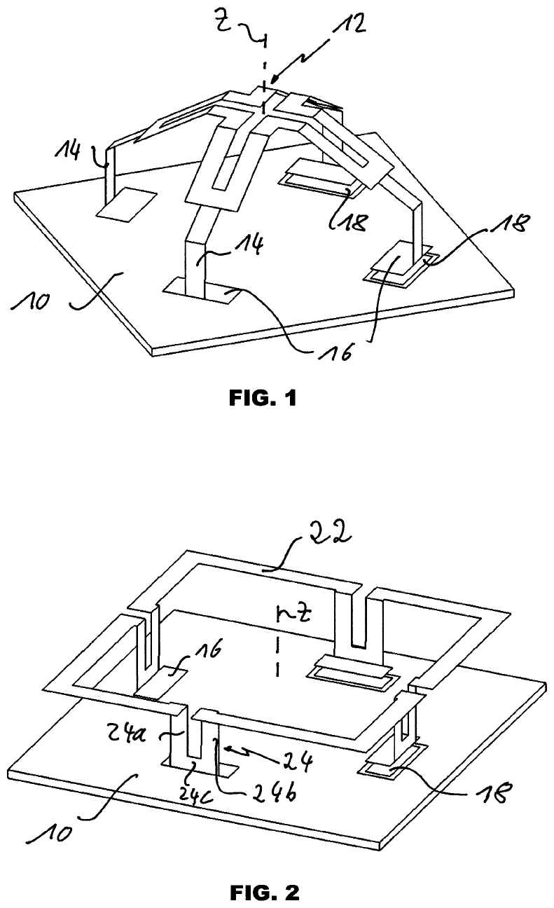

FIG. 1 a perspective view of a satellite antenna in which the corners of the ring conductor are folded in the direction of the center;

FIG. 2 a perspective view of a satellite antenna whose vertical radiators are formed as slit;

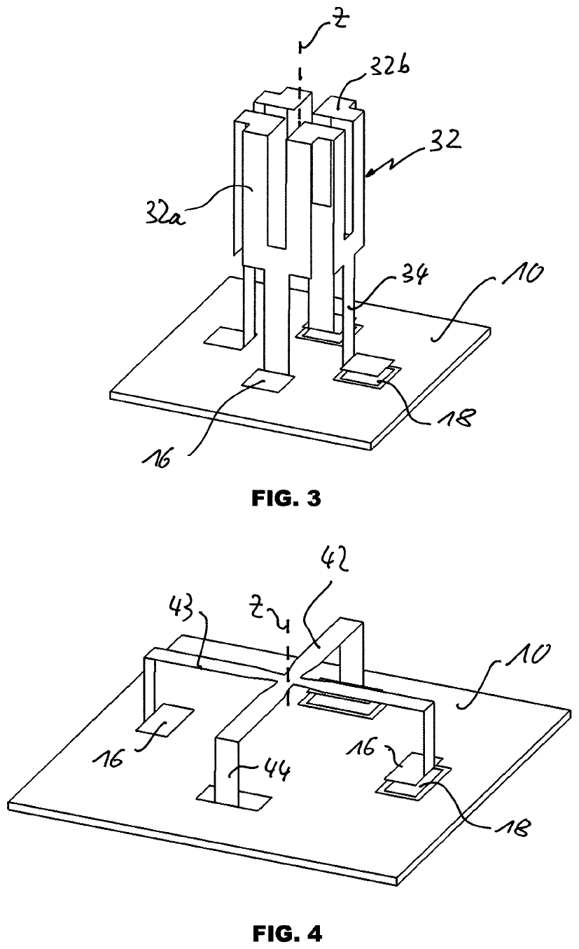

FIG. 3 a perspective view of a satellite antenna whose ring conductor has sections extending orthogonally to the base plate;

FIG. 4 a perspective view of a satellite antenna in which the ring conductor is replaced by two crossing dipoles;

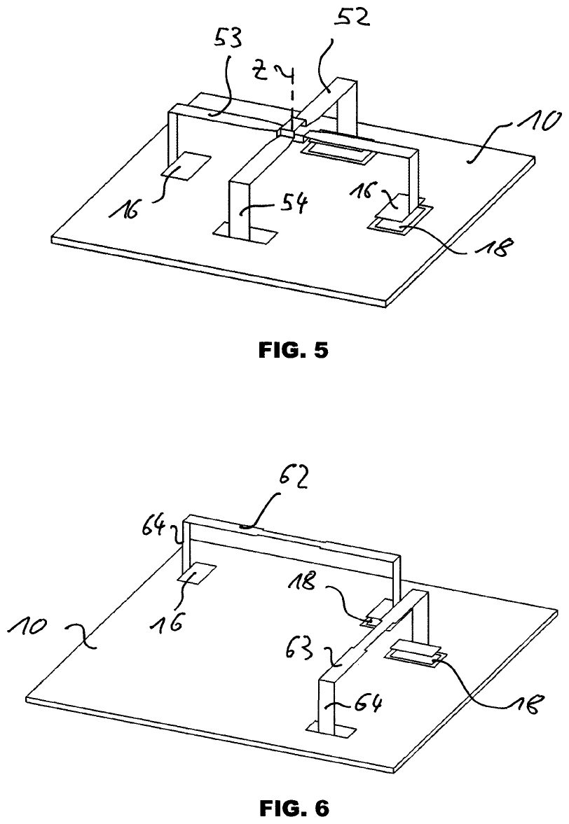

FIG. 5 a perspective view of a satellite antenna with two crossing dipoles that are not galvanically connected to one another;

FIG. 6 a perspective view of a satellite antenna with two non-crossing dipoles;

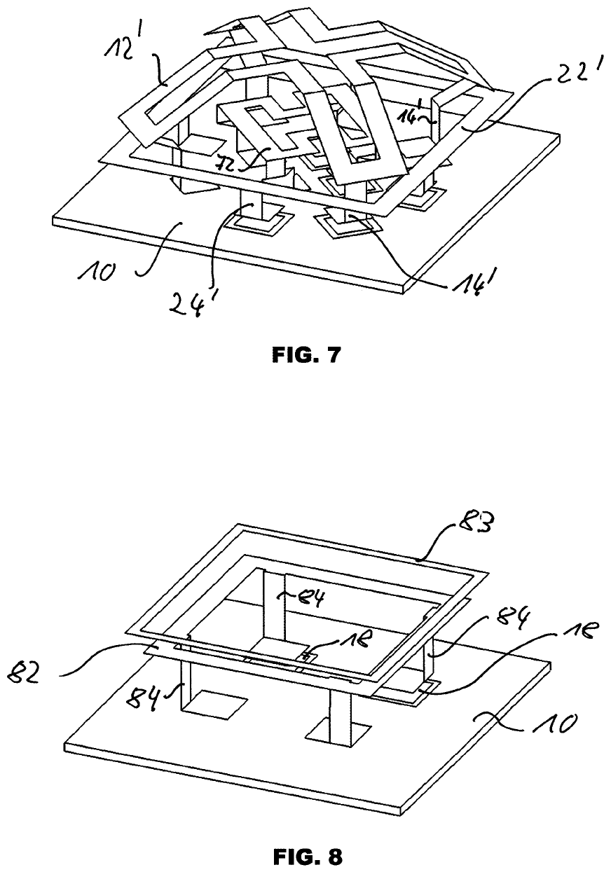

FIG. 7 a perspective view of an antenna arrangement with a plurality of satellite antennas nested in one another; and

FIG. 8 a perspective view of a satellite antenna that has a first ring conductor and a second ring conductor.

In the following description of various embodiments, the same reference symbols are used for identical components.

FIG. 1 shows a first embodiment of a satellite antenna that has an electrically conductive base plate 10 above which an electrically conductive structure is arranged that comprises a ring conductor 12 that has a center Z and that is electrically conductively connected to vertical radiators 14. In the embodiment shown, four vertical radiators 14 are provided that, at their lower ends, are each capacitively coupled to the base plate 10 at a coupling point 16 via a dielectric, not shown. With two adjacent coupling points 16, in the embodiment shown, a feed pad 18 is provided for a feeding and can be connected to an antenna terminal, not shown.

In the embodiment shown in FIG. 1, the ring conductor 12 is cross-shaped in a plan view and it also encloses a cross-shaped surface with its conductor track. Conceptually, the ring conductor 12 is formed from a square whose four corners are folded in the direction of the center Z or are folded upwardly and inwardly. In other words, in a plan view, the ring conductor 12 forms a symmetrical cross whose four legs are slit, starting from the center Z. The ring conductor 12 thus consists of a total of four U-shaped sections, wherein each U has two parallel legs that are connected to one another in the region of the center Z. The lower transverse leg of each U is connected to a respective vertical radiator 14, wherein the vertical radiators 14 are angled at an obtuse angle at their end remote from the coupling point 16 or the base plate 10. As FIG. 1 illustrates, the ring conductor 12 is sectionally inclined with respect to the base plate 10. In the region of the center Z, sections of the ring conductor 12 extend in parallel with the base plate 10 and these sections are adjoined by inclined sections of the ring conductor 12 that are connected to the vertical radiators 14 at their lower ends.

The described shape of the ring conductor 12 is made possible in that the vertical radiators 14 are centrally arranged between the corners of the ring conductor 12 before its corners are folded in the direction of the center Z. However, there is also the possibility of arranging the vertical radiators in the region of the inner, upper corners of the ring conductor near the center.

FIG. 2 shows a further embodiment of a satellite antenna whose ring conductor 22 has a square shape, wherein vertical radiators 24 are each arranged approximately centrally between the four corners of the ring conductor 22. In this embodiment, all four vertical radiators 24 are formed as slit and have the shape of an upwardly open U that has two parallel legs 24a and 24b that are connected to one another by a transverse web 24c that contacts the coupling point 16.

FIG. 3 shows a further embodiment of a satellite antenna that has a monopole-like geometry. In this embodiment, in an unwound plan view, the ring conductor 32 has the same shape as the ring conductor 12 of the embodiment in FIG. 1. However, in the embodiment of FIG. 3, the ring conductor 32 is angled a total of 8 times by 90°.

The ring conductor 32 hereby has a total of four sections 32a that extend orthogonally to the base plate 10, that are each U-shaped and that are connected at their lower side to a respective vertical radiator 34. At the upper side of the U, each leg of a U-shaped section 32a is connected to an L-shaped section 32b that is angled by 90° and that extends in parallel with the base plate 10.

As FIG. 3 illustrates, the sections 32a extending orthogonally to the base plate 10 merge in a coplanar manner into a vertical radiator 16 at their lower sides or at their lower edges.

FIG. 4 shows a further embodiment of a satellite antenna in which the ring conductor has been conceptually reduced in size such that it is reduced to a central connection point. A capacitively fed cross dipole is hereby produced that is formed from two crossing dipoles 42 and 43. The two dipoles 42 and 43 extend orthogonally to one another and cross at the center Z, wherein a respective dipole 42 and 43 is connected to a vertical radiator 44 at its two outer ends. Both dipoles 42 and 43 extend above the base plate 10 spaced apart in parallel therefrom.

FIG. 5 shows an embodiment similar to FIG. 4 that differs from the embodiment shown in FIG. 4 in that the two dipoles 52 and 53 are galvanically isolated. In this embodiment, the two dipoles 52 and 53 are configured as separate conductors that, in the region of the center, are each provided with a U-shaped bend so that the two dipoles 52 and 53 do not touch one another.

FIG. 6 shows a further embodiment of a satellite antenna comprising two dipoles 62 and 63 that, in each case at their ends, are electrically connected to vertical radiators 64. The two dipoles 62 and 63 extend orthogonally to one another, but do not cross and are arranged in an L shape above the base plate 1 in this regard. Both dipoles 62 and 63 can be tapered in their middle third.

FIG. 7 shows an antenna arrangement with a total of three satellite antennas nested in one another whose ring conductors overlap one another in a plan view. A first satellite antenna having a square ring conductor 22′, whose vertical radiators 24′ are centrally arranged between the corners of the ring conductor 22′, is arranged above the base plate 10.

A second satellite antenna is arranged within the ring conductor 22′ of the first satellite antenna and its ring conductor 12′ is configured in the same way as the ring conductor 12 of the embodiment of FIG. 1. However, the vertical radiators 14′ of this satellite antenna are bent outwardly at an obtuse angle at their upper ends so that they, and thus also the ring conductor 12′, cover the ring conductor 22′ of the first satellite antenna.

Finally, a third satellite antenna comprising an approximately square ring conductor 72, which is likewise connected to four vertical radiators, is arranged within and below the first and second satellite antenna.

FIG. 8 shows a further embodiment of a satellite antenna comprising a square ring conductor 82 that is arranged in parallel above a base plate 10. In the region of the four corners of the ring conductor 82, it is connected to vertical radiators 84 that are capacitively coupled to the base plate 10 as in the above-described embodiments, wherein two of the vertical radiators 84 in turn have a coupling point 18 for feeding at an antenna terminal.

In this embodiment, a second ring conductor 83 is arranged slightly above the ring conductor 82, but is not galvanically coupled to the electrically conductive structure consisting of the first ring conductor 82 and the vertical radiators 84. Both ring conductors 82 and 83 have the same geometric shape, wherein the second ring conductor 83 has somewhat narrower tracks and projects beyond the outer contour of the first ring conductor 82. The second ring conductor 83 is held in its position shown in FIG. 8 via fastening means, not shown.

In the above-described embodiments, all the ring conductors can be manufactured in a known manner, for example, as stamped/bent parts. The capacitive coupling to the base plate and the connection to an antenna terminal also take place in a manner known to the skilled person.

1-20. (canceled)

21. A satellite antenna comprising an electrically conductive base plate above which an electrically conductive structure is arranged that comprises a ring conductor having a center that is electrically conductively connected to vertical radiators, wherein the vertical radiators are each capacitively coupled to the base plate at a coupling point and at least one coupling point is connected to an antenna terminal for feeding.

22. The satellite antenna according to claim 21,
wherein the ring conductor is formed as a regular polygon, wherein the vertical radiators are centrally arranged between corners of the ring conductor.

23. The satellite antenna according to claim 21,
wherein corners of the ring conductor are folded in the direction of the center.

24. The satellite antenna according to claim 21,
wherein at least one vertical radiator is formed as slit.

25. The satellite antenna according to claim 21,
wherein at least one vertical radiator is U-shaped.

26. The satellite antenna according to claim 21,
wherein the ring conductor is cross-shaped in a plan view.

27. The satellite antenna according to claim 21,
wherein the ring conductor encloses a cross-shaped surface.

28. The satellite antenna according to claim 21,
wherein the ring conductor is at least sectionally inclined.

29. The satellite antenna according to claim 21,
wherein at least one vertical radiator is angled at an obtuse angle at an end remote from the coupling point.

30. The satellite antenna according to claim 21,
wherein the ring conductor has sections that extend orthogonally to the base plate and that connect to sections extending in parallel with the base plate.

31. The satellite antenna according to claim 21,
wherein sections of the ring conductor extending orthogonally to the base plate merge into a respective vertical radiator.

32. The satellite antenna according to claim 21,
wherein the ring conductor is angled multiple times by 90°.

33. The satellite antenna according to claim 21,
wherein the ring conductor merges in a coplanar manner into the vertical radiators.

34. The satellite antenna according to claim 21,
wherein the ring conductor is replaced by two dipoles that are connected at their ends to a respective vertical radiator.

35. The satellite antenna according to claim 34,
wherein the two dipoles are galvanically coupled at a crossing point.

36. The satellite antenna according to claim 34,
wherein the two dipoles are galvanically isolated at a crossing point.

37. The satellite antenna according to claim 34,
wherein the two dipoles do not cross.

38. The satellite antenna according to claim 21,
wherein a second ring conductor is arranged in a near region of the ring conductor and is not galvanically coupled to the electrically conductive structure.

39. The satellite antenna according to claim 38,
wherein both ring conductors have the same geometric shape.

40. An antenna arrangement comprising at least two satellite antennas according to claim 21, whose ring conductors overlap one another.

41. The satellite antenna according to claim 24,
wherein said at least one vertical radiator has two legs spaced apart in parallel.

42. The satellite antenna according to claim 28,
wherein the ring conductor is at least sectionally dome-shaped with respect to the base plate.

43. The satellite antenna according to claim 32,
wherein the ring conductor is angled 8 times by 90°.

44. The satellite antenna according to claim 30,
wherein the ring conductor has sections that extend orthogonally to the base plate and that connect to sections extending in parallel with the base plate.

45. The satellite antenna according to claim 34,
wherein the two dipoles cross.

46. The satellite antenna according to claim 37,
wherein the two dipoles are arranged orthogonally to one another.

47. The satellite antenna according to claim 38,
wherein the second ring conductor is arranged above the ring conductor.
